(19) United States
(12) Patent Application Publication
(10) Pub. No.: US 2010/0156090 A1
(43) Pub. Date: Jun. 24, 2010

(54) METHOD AND APPARATUS FOR MAKING A FLUID CONNECTION TO A CONTAINER

(75) Inventor: Thomas Nelson O'Connor, Jackson, NJ (US)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: New Brunswick Scientific Company ,nc., Edison, NJ (US)

(21) Appl. No.: 12/601,061

(22) PCT Filed: May 23, 2008
(86) PCT No.: PCT/US2008/064698

§ 371 Date: Nov. 20, 2009

Related U.S. Application Data
(60) Provisional application No. 60/939,691, filed on May 23, 2007.

(51) Int. Cl. F16L 35/00

(52) U.S. Cl. 285/24

(57) ABSTRACT

A method and apparatus for connecting a container (102) to a fluid conduit (108), including a container (102) having an interior and an exterior and a receptacle (104) with an opening and an exterior sealing surface adjoining and surrounding the opening, a fluid conduit (108) having at one end a collar (304), either affixed to or separate from the conduit (108), the collar (304) affixed to the receptacle (104) with a seal (106) placed between the receptacle (104) and the fluid conduit (108).

### CROSS REFERENCE TO RELATED APPLICATIONS

This application claims the priority of provisional U.S. application Ser. No. 60/939,691 filed on May 23, 2007 and entitled Method for Making a Fluid Connection to a Container by Thomas Nelson O Connor, the entire contents and substance of which are hereby incorporated in total by reference.

### FIELD OF THE INVENTION

This invention relates to a method for connecting a container and a fluid conduit.

### BACKGROUND OF THE INVENTION

When dealing with a container, a method is needed for joining the piping, tubing or instrumentation to the container. The seal between the container and conduit are crucial, particularly in a sanitary application. This is typically accomplished by welding a fitting into the container, which can be quite costly particularly in a sanitary container which requires a great deal of polishing and a smooth surface finish.

### SUMMARY OF THE INVENTION

An aspect of the present invention provides a container/fluid conduit connector assembly including a container having an interior and an exterior and a receptacle. The receptacle includes an opening and an exterior sealing surface adjoining and surrounding the opening. The assembly also includes a fluid conduit having at one end a collar, the collar being affixed to the receptacle with a seal placed between the receptacle and the fluid conduit. The seal may be a gasket.

In various aspects of the present invention, the container and fluid conduit may be made of metal, plastic, glass, ceramic, rubber or a composite material. Also in various aspects of the invention the collar may be affixed to the receptacle by threading, fasteners or clamps.

Another aspect of the invention provides a container having an interior and an exterior and a receptacle, the receptacle including an opening, and an exterior sealing surface adjoining and surrounding the opening. Also included are a fluid conduit having at a lip at least one end, a collar sized and fitted over the fluid conduit and placed adjacent to the lip, the collar further affixed to the receptacle by one or more fastener, and a seal placed between the receptacle and the fluid conduit.

A further aspect of the invention provides a method of connecting a fluid conduit to a container. The method includes providing a container having an interior, an exterior and a receptacle. The receptacle includes an opening and an exterior sealing surface adjoining and surrounding the opening. The method further includes providing a fluid conduit having a collar at at least one end, placing a seal on the exterior sealing surface of the receptacle, placing the collar against the seal, and affixing the collar to the receptacle by one or more fastener.

Another aspect of the invention provides for the fluid conduit being separate from the collar, with the conduit having a lip or flange at one end and the collar fitting over the conduit and against the lip or flange, then the collar being fastened to the receptacle with a seal between the lip or flange and the receptacle.

### BRIEF DESCRIPTION OF THE DRAWINGS

FIG. 1 is an exploded 3-dimensional view of a fluid connection with the collar integral to the fluid conduit, in accordance with an embodiment of the present invention;

FIG. 2 is a cross-section of a fluid connection with a collar integral to the fluid conduit, in accordance with an embodiment of the present invention; and

FIG. 3 is a cross-section of a fluid connection with the collar separate from the fluid conduit, in accordance with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to one embodiment or an embodiment means that a particular feature, structure or characteristic described in connection with the embodiment is included in at least one embodiment of the invention. The appearances of the phrase in an embodiment in various places in the specification are not necessarily all referring to the same embodiment.

The present invention advantageously provides for establishment of a connection between the container and a fluid conduit which is sanitary in design, due to the proximity of the seal to the inner surface of the container.

In various embodiments, the present invention also advantageously reduces the possibility of a leak or failure by eliminating the need of welding, polishing or grinding a fitting into or onto the container wall. By eliminating the need for such welding, polishing or grinding, the present invention also allows container fabrication at greatly reduced costs.

The present invention also allows the creation of a modular container having no set predetermined fittings. Several collar arrangements may be made to adapt multiple fluid conduits to the container. These collared arrangements would be interchangeable, creating a container that is truly modular.

A preferred embodiment of the invention features a container wall in which an integral receptacle is placed. The receptacle consists of an opening, a sealing surface and a method of joining a collar to capture the fluid conduit or adapt to the fluid conduit.

The opening of the receptacle provides a means of fluid exchange between the conduit and the container. The sealing surface is mounted at the base of the receptacle. This is the point at which the fluid conduit is joined to the container. In an embodiment of the invention, a gasket or seal of some type is placed on the sealing surface and the fluid conduit is then pressed up against the gasket. A collar may be used to secure the conduit in place and generate sufficient force to seal the connection between the conduit and the container. The collar may be one piece or multiple pieces. The collar may be threaded into the receptacle, held in place by a fastener or held in place by a clamp. The collar may also be joined or integral to the fluid connector to act as an adapter between the conduit and container.

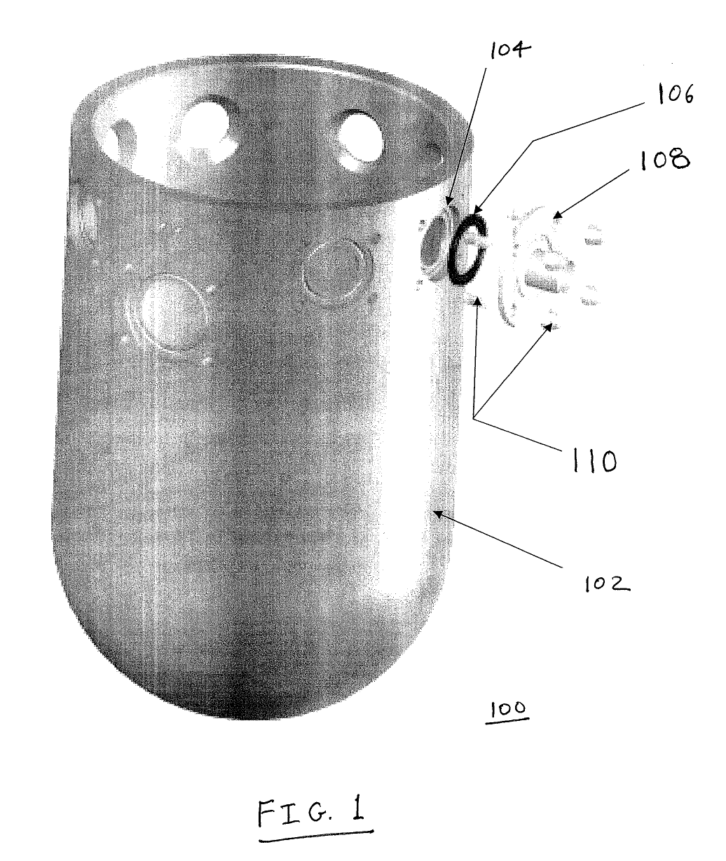

FIG. 1 is a an exploded 3-dimensional view 100 of a fluid connection with the collar integral to the fluid conduit 108.

In an embodiment of the invention as depicted in FIG. 1, a container 102 having one or more receptacle 104 is provided. A seal 106 is placed within the receptacle between the receptacle 104 and a collar 108 having a fluid conduit. The seal 106 preferably resides within the receptacle 104 and prevents fluid leakage from the gap between the collar 108 and receptacle 104. Such a leakage prevention may be provided by using fasteners 110 to affix the collar 108 firmly against the seal 106.

The container 102 and collar 108 may be metallic, plastic, glass, ceramic or any other material or combination of materials. The receptacle 104 is preferably formed during the container fabrication process, or may be added later.

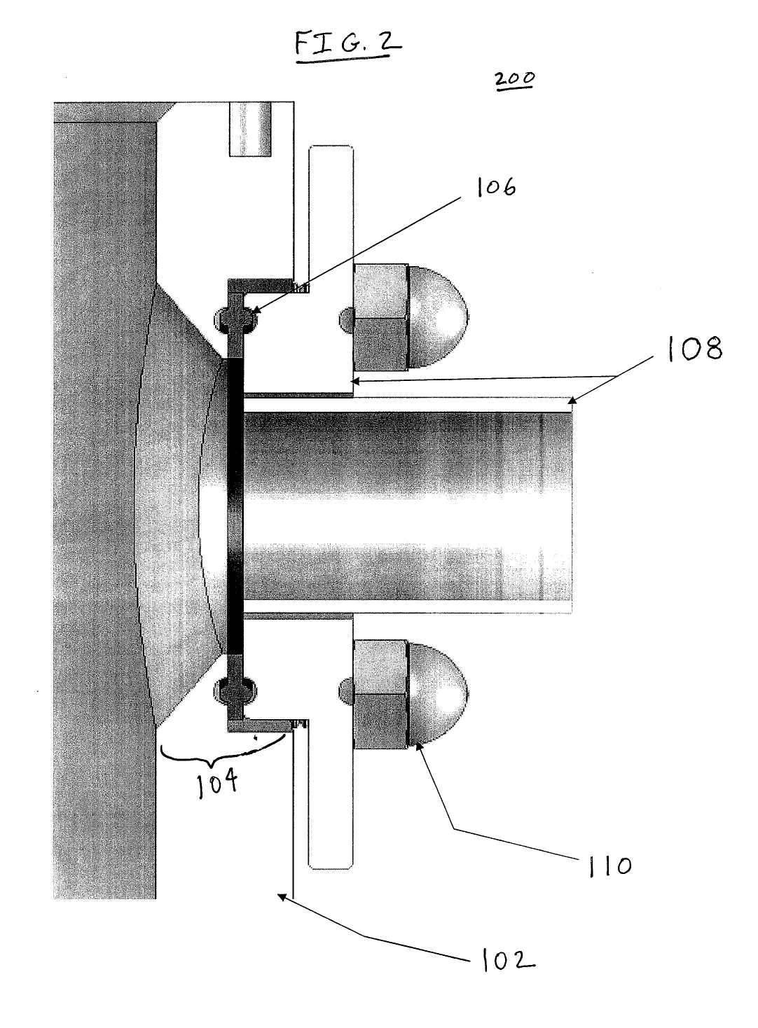

Referring now to FIG. 2, a cross-sectional view 200 of a fluid connection with a collar 108 integral to the fluid conduit 108, a more detailed view of an embodiment of the invention is provided. A container 102 having a receptacle 104 as described above is depicted with the seal 106 or gasket between the collar 108 having a fluid conduit and the receptacle 104. Fasteners 110 are used to firmly attach the collar 108 to the receptacle, applying pressure to the seal 106.

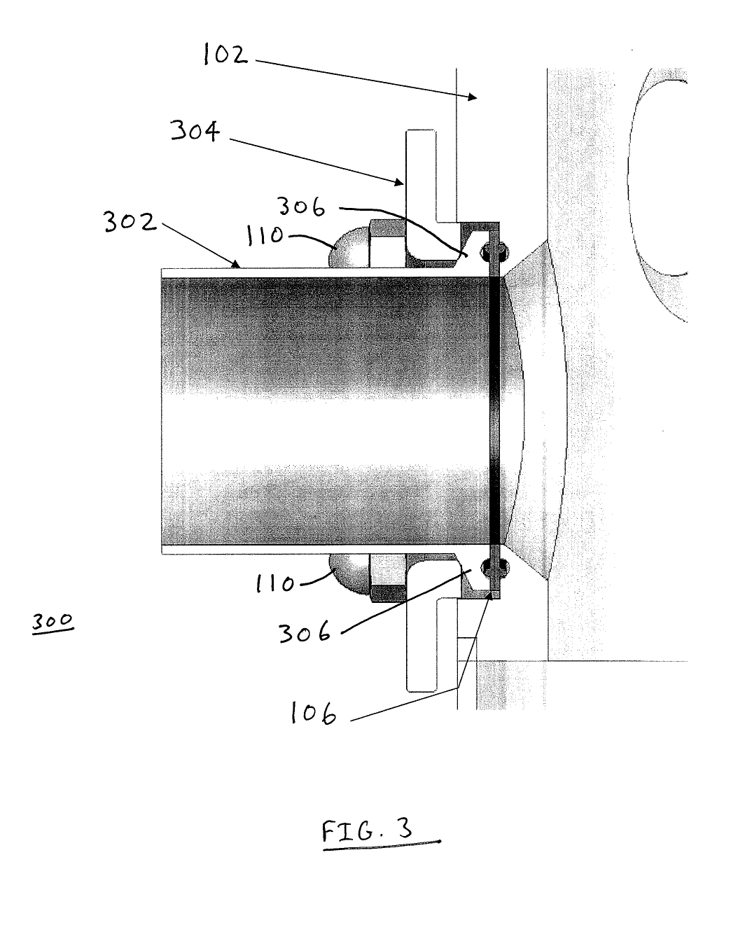

Another embodiment of the present invention is provided in FIG. 3, a cross-sectional view 300 of a fluid connection with the collar 304 separate from the fluid conduit 302. A container 102 having a receptacle 104 is depicted with the seal 106 or gasket between the collar 304 and the receptacle 104. The collar 304 fits over a lip or flange 306 on the separate fluid conduit 302. Fasteners 110 are used to firmly attach the collar 108 to the receptacle, applying pressure to the seal 106.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### INDUSTRIAL APPLICABILITY

In numerous fields, including the sanitation, industrial chemistry and pharmaceutical industries, there is significant interest in connecting containers with fluid conduits in such a manner that leakage is prevented yet cost of the container is minimal.

1. A container/fluid conduit connector assembly comprising:
a container (102) having an interior and an exterior and a container wall comprising an integral receptacle (104), the receptacle (104) comprising an opening, and an exterior sealing surface adjoining and surrounding the opening;
a fluid conduit (108) having at one end a collar, the collar affixed to the receptacle (104); and
a seal (106) placed between the receptacle (104) and the fluid conduit (108).

2. The container/fluid conduit connector according to claim 1, wherein the container (102) is comprised of one of: metal, plastic, ceramic, glass, rubber or composite material.

3. The container/fluid conduit connector according to claim 1, wherein the fluid conduit (108) is comprised of one of: metal, plastic, ceramic, glass, rubber, or composite material.

4. The container/fluid conduit connector according to claim 1, wherein the collar and receptacle (104) are threaded and the collar is affixed to the receptacle by threading.

5. The container/fluid conduit connector according to claim 1, wherein the collar is affixed to the receptacle by one or more fastener (110).

6. The container/fluid conduit connector according to claim 1, wherein the collar is affixed to the receptacle by one or more clamp.

7. The container/fluid conduit connector according to claim 1, wherein the seal (106) is one or more gasket.

8. A container/fluid conduit connector assembly comprising:
a container (102) having an interior and an exterior and a container wall comprising an integral receptacle (104), the receptacle (104) comprising an opening, and an exterior sealing surface adjoining and surrounding the opening;
a fluid conduit (302) having a lip (306) at at least one end;
a collar (304), the collar (304) sized and fitted over the fluid conduit (302) and placed adjacent to the lip (306), the collar (304) further affixed to the receptacle (104) by one or more fastener (110); and
a seal (106) placed between the receptacle (104) and the fluid conduit (302).

9. A method of connecting a fluid conduit (108) to a container (102), the method comprising:
providing a container (102) having an interior, an exterior and a container wall comprising an integral receptacle (104), the receptacle (104) comprising an opening and an exterior sealing surface adjoining and surrounding the opening;
providing a fluid conduit (108) having a collar at at least one end;
placing a seal (106) on the exterior sealing surface of the receptacle (104);
placing the collar against the seal (106); and
affixing the collar to the receptacle (104) by one or more fastener (110).

10. A method of connecting a fluid conduit (302) to a container (102), the method comprising:
providing a container (102) having an interior, an exterior and a container wall comprising an integral receptacle (104), said receptacle (104) comprising an opening and an exterior sealing surface adjoining and surrounding the opening;
providing a fluid conduit (302) with a lip (306) at at least one end;
providing a collar (304) sized to fit around the fluid conduit (302) and against the lip (306);
placing a seal (106) on the exterior sealing surface of the receptacle (104);
placing the collar (304) around the fluid conduit (302), against the lip (306) and against the seal (106); and
affixing the collar (304) to the receptacle (104) by one or more fastener (110).
